(19) United States
(12) Patent Application Publication
(10) Pub. No.: US 2024/0326919 A1
(43) Pub. Date: Oct. 3, 2024

(54) PAINTABLE FIBER-REINFORCED COMPOSITE PANEL

(71) Applicant: GM GLOBAL TECHNOLOGY OPERATIONS LLC, Detroit, MI (US)

(72) Inventors: Bradley Allen NEWCOMB, Troy, MI (US); Thomas S. Prevost, West Bloomfield, MI (US); Bhavesh Shah, Troy, MI (US); Julien P. Mourou, Bloomfield Hills, MI (US); Joseph M. Polewarczyk, Lake Orion, MI (US); Xiaosong Huang, Novi, MI (US); James C. O'Kane, Shelby Twp., MI (US)

(21) Appl. No.: 18/128,591

(22) Filed: Mar. 30, 2023

(51) Int. Cl. B62D 25/02; B29C 45/00; B29C 45/14; B29C 70/06; B29C 70/54; B29C 35/02; B29L 9/00

(52) U.S. Cl. CPC B62D 25/02; B29C 45/0005; B29C 45/14336; B29C 45/14688; B29C 45/14786; B29C 70/06; B29C 70/54; B29C 2035/0283; B29L 2009/006

(57) ABSTRACT

A method for manufacturing a composite panel includes arranging a continuous reinforcing fiber on a surface in a predetermined pattern to form a structural insert; encapsulating the structural insert in a first resin to form a composite panel; and at least one of painting an exterior surface of the composite panel; applying a film to the exterior surface of the composite panel; and using a transparent resin for the first resin to allow light to transmit through at least a portion of the composite panel.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to composite panels, and more particularly to composite panels including one or more continuous reinforcing fibers and resin.

The efficiency of a vehicle is impacted by the weight of the vehicle. To reduce weight, some vehicles use structural composites instead of stamped steel or aluminum.

### SUMMARY

A method for manufacturing a composite panel includes arranging a continuous reinforcing fiber on a surface in a predetermined pattern to form a structural insert; encapsulating the structural insert in a first resin to form a composite panel; and at least one of painting an exterior surface of the composite panel; applying a film to the exterior surface of the composite panel; and using a transparent resin for the first resin to allow light to transmit through at least a portion of the composite panel.

In other features, the continuous reinforcing fiber is selected from a group consisting of carbon, glass, basalt, natural fibers, and combinations thereof. The continuous reinforcing fiber comprises fibers having a stiffness and strength that is greater than the first resin. The continuous reinforcing fiber comprises dry fibers. The continuous reinforcing fiber includes fibers and thermoset resin encapsulated in a sheath.

In other features, the method includes applying at least one of heat and pressure to the structural insert prior to encapsulation in the first resin. The continuous reinforcing fiber includes fibers and thermoplastic resin encapsulated in an outer layer. The method includes encapsulating the structural insert in one of thermoplastic and thermoset resin prior to encapsulation in the first resin.

In other features, the surface comprises one side surface of a body panel, and the structural insert is encapsulated on the one side surface of the body panel using the first resin.

In other features, another side surface of the body panel is painted.

In other features, the composite panel has a composite density less than 1.50 g/cc, a tensile modulus greater than 2000 MPa in at least one direction, a coefficient of linear thermal expansion (CLTE) in at least one direction less than 40 ppm/C, a tensile strength in at least one direction that is greater than or equal to 50 MPa, and a composite thickness in a predetermined range from 2 mm to 8 mm. The continuous reinforcing fiber of the structural insert has thickness variations and extends non-uniformly in three planes.

In other features, the method includes selecting one or more fibers in the continuous reinforcing fiber and a fiber volume percentage of the continuous reinforcing fiber relative to the first resin to provide a first coefficient of linear thermal expansion of the composite panel in at least one direction to be within a predetermined range of a second coefficient of linear thermal expansion of a structure including a mounting location for the composite panel.

In other features, the structural insert is anisotropic to vary at least one of local stiffness, thermal expansion, and strength as a function of location within the composite panel. The method includes mixing the first resin with at least one of short fibers, long fibers, and one or more minerals prior to encapsulating the structural insert.

A method for manufacturing a composite panel includes arranging a continuous reinforcing fiber on a surface in a predetermined pattern to form a structural insert. The continuous reinforcing fiber is selected from a group consisting of dry fibers, fibers and thermoset resin arranged in an outer layer, and fibers and thermoplastic resin arranged in an outer layer. The continuous reinforcing fiber is selected from a group consisting of carbon, glass, basalt, natural fibers, and combinations thereof. The method includes encapsulating the structural insert in a first resin to form a composite panel. The method includes at least one of painting an exterior surface of the composite panel; applying a film to the exterior surface of the composite panel; and using a transparent resin for the first resin to allow light to transmit through at least a portion of the composite panel.

In other features, the continuous reinforcing fiber comprises the dry fibers. The method includes applying at least one of heat and pressure to the structural insert prior to encapsulation in the first resin. The surface comprises one side surface of a body panel, the structural insert is encapsulated on the one side surface of the body panel using the first resin, and another side surface of the body panel is painted.

In other features, the composite panel has a composite density less than 1.50 g/cc, a tensile modulus greater than 2000 MPa in at least one direction, a coefficient of linear thermal expansion (CLTE) in at least one direction less than 40 ppm/C, a tensile strength in at least one direction that is greater than or equal to 50 MPa, and a composite thickness in a predetermined range from 2 mm to 8 mm.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a plan view of a fiber-reinforced composite panel such as a roof panel mounted in an opening in another structure such as a roof of a vehicle according to the present disclosure;

FIG. 2A is a plan view of reinforcing fibers arranged in a predetermined pattern to form a structural insert according to the present disclosure;

FIG. 2B is a plan view of a composite panel including the structural insert encapsulated in resin according to the present disclosure;

FIG. 3 is a side cross-sectional view of another example of a composite panel according to the present disclosure; and

FIG. 4 is a flowchart of a method for manufacturing a composite panel according to the present disclosure.

In the drawings, reference numbers may be reused to identify similar and/or identical elements.

### DETAILED DESCRIPTION

While the following description relates to a composite panel including a structural insert with one or more continuous reinforcing fibers arranged in a predetermined pattern and encapsulated in resin that is used as a structural component in a vehicle, the composite panels can be used in non-vehicular applications.

In commonly assigned U.S. patent application Ser. No. 17/899,127, filed on Aug. 30, 2022, and entitled “Fiber Reinforced Thermoplastic Composite Body Panel”, which is hereby incorporated by reference in its entirety, composite panels include continuous reinforcing fibers that are arranged in a predetermined pattern on a backing substrate and encapsulated in resin. After the reinforcing fibers are positioned, the reinforcing fibers and the backing substrate are encapsulated in resin.

More particularly, the reinforcing fibers are placed on the backing substrate and stitched in position using tailored fiber placement (TFP) or using another placement device to create the predetermined pattern. Then, the reinforcing fibers are optionally trimmed and consolidated if needed. For example, if the reinforcing fibers include thermoset resin, a consolidation step can be performed using heat and/or pressure. For example, if the reinforcing fibers are dry fibers, a consolidation step can be performed by injecting resin and using heat and/or pressure. Then, the backing substrate and the stitched reinforcing fibers are encapsulated in thermoplastic resin or thermoset resin and heat and/or pressure may be applied.

In the composite structures according to the present disclosure, the backing sheet is no longer used. Rather, the reinforcing fibers are arranged in a predetermined pattern on a surface (rather than on a backing substrate) to create a structural insert.

In some examples, the reinforcing fibers include thermoplastic resin. During placement of the reinforcing fibers, the placement device may partially heat the thermoplastic resin to allow bending of the reinforcing fibers and/or cause the reinforcing fibers to be tacky and to stick to the surface in the placement location. The thermoplastic resin in the reinforcing fibers cools and solidifies after placement.

In some examples, the reinforcing fibers include dry fibers that are placed on a surface or in a mold in a desired shape of the structural insert using tailored fiber placement or another placement device. In some examples, thermoplastic or thermoset resin is injected into the mold around the dry fibers to consolidate the fibers in the desired shape of the structural insert.

In some examples, the reinforcing fibers include thermoset resin. During placement, the placement device may partially heat the thermoset resin in the reinforcing fibers enough to allow the reinforcing fibers to bend and/or to cause the reinforcing fibers to stick to the surface in the correct location. After placement, heat or pressure can be used to consolidate the reinforcing fibers in the predetermined pattern.

In some examples, the structural insert includes an injection molded fiber reinforced material. For example, glass fiber, carbon fiber, or other fibers are used as reinforcing fibers. While not nearly as strong or as stiff as a continuous fiber reinforcement, the injection molded fiber reinforced material allows injection molding a pattern in a first step followed by over molding with a second resin in a second step.

For example, the reinforcing fibers can be arranged on a surface such as an inner mold surface prior to encapsulation in resin. In other examples, the reinforcing fibers are arranged on another type of surface (that is not the inner mold surface) such as a metal surface or table at room temperature. Then, the structural insert is arranged in another mold and encapsulated in resin.

The structural insert including the one or more continuous reinforcing fibers is encapsulated in a thermoplastic resin or a thermoset resin. Heat and/or pressure can be applied. In some examples, a volume percentage of the one or more continuous reinforcing fibers relative to the volume of the composite panel is controlled within a predetermined range to provide a first predetermined coefficient of linear thermal expansion (CLTE) that is within a predetermined range of a second CLTE of surface including a mounting location.

In some examples, a surface of the composite panel is painted or a film is applied. In some examples, fibers of the one or more continuous reinforcing fibers, the resin, the volume percentage, and the shape of the structural insert are selected to form a composite structure having a CLTE that is less than 40, 35, or 30 ppm/K. For example, use of unidirectional carbon fiber (k=1) with a fiber volume percentage of 1.6% in mineral filled polypropylene (mfPP) or glass reinforced polypropylene (gfPP) resin produces CLTE of 21 and 30 ppm/K and densities in g/cc of 1.11 and 1.15, respectively. At 3% fiber volume percentage, additional resins such as polycarbonate/acrylonitrile butadiene styrene (ABS) (PC/ABS), (PC)/ABS/poly(methyl methacrylate) PMMA (PC/ABS/PMMA), PP, mfPP, gfPP, and polyamide (or nylon) 12 (PA12) produce CLTEs of 20, 19, 19, 14, 22, and 20 ppm/K and densities in g/cc of 1.17, 1.09, 0.93, 1.12, 1.16, and 1.04, respectively. Higher fiber percentages generally reduce the CLTE and increase the density. Fibers such as glass fibers and basalt fibers generally require higher fiber volume percentages (e.g., 5% for glass fibers and mfPP with CLTE of 24 and density of 1.17 g/cc; 5% for basalt fibers and mfPP with CLTE of 24 ppm/K and density of 1.19 g/cc) to provide a suitable CLTE.

For example, use of random carbon fiber reinforcement (k=⅜) with a fiber volume percentage of 1.6% and PC/ABS, PC/ABS/PMMA, PP, mfPP, gfPP, and PA12 have higher CLTEs of 50, 53, 52, 32, 40, and 56 ppm/K and densities in g/cc of 1.16, 1.08, 0.92, 1.11, 1.15, and 1.13, respectively. At 3% fiber volume percentage, PC/ABS, PC/ABS/PMMA, PP, mfPP, gfPP, and PA12 have CLTE of 38, 38, 38, 25, 34, and 40 ppm/K and densities in g/cc of 1.17, 1.09, 0.93, 1.12, 1.16, and 1.04, respectively. Higher fiber percentages further reduce the CLTE and increase the density. Fibers such as glass fibers and basalt fibers generally require higher fiber volume percentages (e.g., 15% for glass fibers and PP with CLTE of 23 and density of 1.15 g/cc; 15% for basalt fibers and PP with CLTE of 28 and density of 1.15 g/cc) to a suitable CLTE.

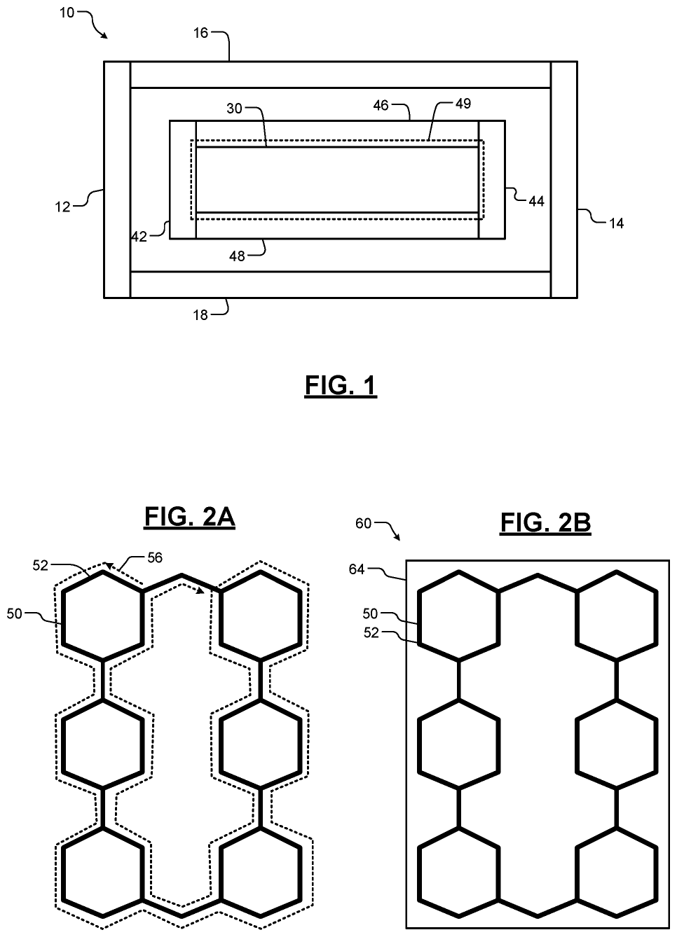

Referring now to FIG. 1, an example of a roof 10 of a vehicle is shown. The roof 10 includes a front header 12, a rear header 14, a passenger side rail 16, and a driver side rail 18. An opening 30 in the roof 10 is defined between a front header 42, a rear header 44, and side rails 46 and 48. A composite panel 49 is arranged over the opening 30 and bonded to the front header 42, the rear header 44, and the side rails 46 and 48 of the roof 10.

As the temperature increases or decreases, the size of the opening 30 in the roof 10 increases and decreases. If the composite panel 49 has a coefficient of linear thermal expansion (CLTE) in one or more directions that is significantly different than the rest of the roof structure defining the opening, the size of the composite panel 49 will increase and decrease at a different rate than the rest of the roof 10, which may cause the composite panel 49 to deform. In some applications, a low stiffness adhesive can be used to offset the differences in expansion and/or contraction. In other applications such as structural applications, a high stiffness adhesive and/or fasteners are used and another approach needs to be used to reduce deformation caused by differences in CLTE.

In some examples described further below, the selected resin, the selected fibers in the one or more continuous reinforcing fibers, and a fiber volume percentage of the reinforcing fibers in the composite panel 49 relative to the resin are selected to produce a CLTE in one or more directions that is less than 40, 35, or 30 ppm/K.

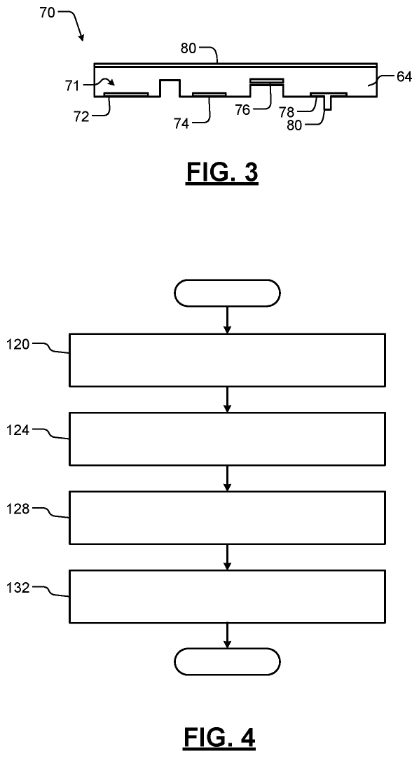

Referring now to FIGS. 2A and 2B, a structural insert 50 includes one or more continuous reinforcing fibers 52 that are arranged on a surface in a predetermined pattern to define a shape of the structural insert 50. For example, a fiber tow that includes fibers and thermoset or thermoplastic resin can be used. An example of a placement path 56 for the one or more continuous reinforcing fibers 52 is shown. In some examples, one continuous reinforcing fiber is used as shown. In other examples, more than one of the continuous reinforcing fibers 52 is used to define the structural insert 50. While the structural insert 50 is arranged in one plane in some examples, the structural insert 54 can be arranged multiple planes to define a three dimensional shape. For example, the surface upon which the continuous reinforcing fibers 52 are placed can be non-planar.

In some examples, the one or more continuous reinforcing fibers 52 are placed using automated fiber placement or tailored fiber placement (TFP) methods using robots. In some examples, the one or more continuous reinforcing fibers 52 are optionally heated during placement on the surface and then allowed to cool on the surface. In some examples, the one or more continuous reinforcing fibers 52 include dry continuous fibers that are optionally arranged in a sheath, fibers impregnated with thermoplastic resin that are optionally arranged in a sheath, and/or fibers impregnated with thermoset resin that are optionally arranged in an outer layer such as a sheath, a thermoplastic tape or other material.

In some examples, the fibers in the one or more continuous reinforcing fibers 52 include carbon, glass, basalt, and/or other reinforcing fibers. In some examples, the reinforcing fibers are commingled with other types of reinforcing fibers and/or with thermoplastic fibers such as nylon, acrylic, or polycarbonate. In some examples, carbon fiber reinforcing fibers are commingled with thermoplastic fibers. In some examples, the one or more continuous reinforcing fibers 52 are trimmed and/or consolidated using heat and/or pressure after placement.

In FIG. 2B, the structural insert 50 including the one or more continuous reinforcing fibers 52 is encapsulated in resin to form a composite panel 60. In some examples, a surface of the composite panel 60 is covered in film and/or painted.

Referring now to FIG. 3, a cross-sectional side view of another example of a composite panel 70 is shown. A structural insert 71 can have a symmetric or asymmetric shape and can be located in one or more planes. The structural insert 71 can be located fully within the resin 64 and/or extend partially outside of the resin 64. In some examples, the structural insert 71 is arranged on spacers during encapsulation to fully encapsulate the structural insert 71. In other examples, the structural insert 71 is located on a bottom surface of a mold.

For example in the side cross-sectional view, the structural insert 71 includes portions 72, 74, 76 that are at least partially located along a bottom surface of the composite panel 60. The portion 78 of the structural insert 50 includes a lower projection 80 extending downwardly and outside of the resin 64 encapsulating the structural insert 71. The portion 76 is located in a plane that is spaced above a plane including the bottom surface.

Referring now to FIG. 4, a method 100 for manufacturing the composite panel is shown. At 120, the one or more continuous reinforcing fibers are placed on a surface in a predetermined pattern desired for the structural insert. In some examples, the one or more continuous reinforcing fibers are heated during placement to allow bending and/or to make the continuous reinforcing fibers tacky to that they are held in position on the surface. At 124, the one or more continuous reinforcing fibers are optionally trimmed and/or consolidated using heat and/or pressure. At 128, the structural insert is encapsulated in resin to form a composite panel. At 132, a surface of the composite panel is optionally painted and/or covered in film.

In some examples, the composite panel has a density less than 1.50 g/cc, a tensile modulus greater than 2000 MPa in at least one direction, CLTE in at least one direction less than 40 ppm/K, tensile strength in at least one direction that is greater than or equal to 50 MPa, and a composite thickness in a predetermined range from 0.2 mm to 8 mm.

In some examples, the fibers are continuous, locally applied, and include at least one of carbon, glass, basalt, natural fiber, or other reinforcement fibers with a stiffness and strength greater than that of the encapsulating resin. In some examples, the continuous reinforcing fibers are in the form of dry fibers that are encapsulated in a thermoset or thermoplastic resin to form a structural composite.

In some examples, the fiber reinforcement is consolidated with a thermoplastic or thermoset matrix (e.g., carbon fiber epoxy prepreg, carbon fiber towpreg, carbon fiber reinforced thermoplastic, commingled carbon/thermoplastic fiber), consolidated into a structural insert, and overmolded with a thermoset or thermoplastic resin.

In some examples, the structural insert is formed through a consolidation process using heat and/or pressure prior to encapsulation. In some examples, the is insert has local, non-uniform, thickness variations.

In some examples, local stiffness, thermal expansion, strength, and other thermo-mechanical properties of the reinforcing fibers vary as a function of a location within the composite panel. The reinforcing fibers are anisotropic. It is their orientation within the insert and the final molded panel that determine the insert or the panel being described as planar isotropic (equal properties in two dimensions) or anisotropic. Fiber orientation is controller using the automated tape layup process which allows control of the fiber anisotropic nature of the molded panel.

In some examples, the composite panel is painted. In other examples, the composite panel is covered with film. In some examples, the composite panel is formed using a transparent, translucent, or semi-transparent resin material to allow light to transmit through portions of the composite panel. In some examples, the structural insert is encapsulated in resin mixed with short fibers, long fibers, and/or one or more minerals.

In some examples, the structural insert is formed using a first injection process and structural insert is overmolded in resin using a second injection process. In some examples, the structural insert is formed using a first injection process in a first mold and then inserted into a second mold for encapsulation using a second resin. In some examples, the second resin is the same as or different than the first resin.

In some examples, the reinforcing fibers include one or more fibers selected from a group consisting of carbon, glass, basalt, flax, hemp, pineapple, and cellulose. In some examples, first fibers (selected from a group consisting of carbon, glass, basalt, flax, hemp, pineapple, and cellulose) are commingled with second fibers selected from a group consisting of polycarbonate, nylon, polyetheretherketone (PEEK), polyetherimide (PEI), polyphenylene sulfide (PPS), polyester, polyethylene, and polypropylene in order to consolidate the fiber preform prior to over-molding. In some examples, the plurality of fibers has a shape selected from the group consisting of cylindrical, flat, or both cylindrical and flat.

Suitable fiber materials may include carbon fibers (e.g., carbon black, carbon nanotubes, talc, fibers derived from polyacrylonitrile, cellulosic precursors, and/or pitch precursors), glass fibers (e.g., fiber glass, quartz), basalt fibers, aramid fibers (e.g., KEVLAR®, polyphenylene benzobisoxazole (PBO)), polyethylene fibers (e.g., high-strength ultra-high molecular weight (UHMW) polyethylene), polypropylene fibers (e.g., high-strength polypropylene), natural fibers (e.g., cotton, flax, cellulose, spider silk), and combinations thereof, by way of example. In some examples, the reinforcing fibers comprise fiber tow including one or more continuous fibers and an outer layer or sheath surrounding the one or more continuous fibers.

In some examples, the resin includes one or more materials selected from a group consisting of polycarbonate, polypropylene, epoxy, polyurethane, polymethylmethacrylate, a polyamide, styrene-acrylonitrile, methyl methacrylate-acrylonitrile-butadiene-styrene, styrene methyl methacrylate, polyester, vinyl ester, polybutylene terephthalate, polyethylene terephthalate, polyimides, and/or other transparent or opaque polymer. The resin may be a thermoset resin or a thermoplastic resin that is substantially transparent when free of fibers or opaque.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a composite panel, comprising:
arranging a continuous reinforcing fiber on a surface in a predetermined pattern to form a structural insert; and
encapsulating the structural insert in a first resin to form a composite panel; and
at least one of:
painting an exterior surface of the composite panel;
applying a film to the exterior surface of the composite panel; and
using a transparent resin for the first resin to allow light to transmit through at least a portion of the composite panel.

2. The method of claim 1, wherein the continuous reinforcing fiber is selected from a group consisting of carbon, glass, basalt, natural fibers, and combinations thereof.

3. The method of claim 1, wherein the continuous reinforcing fiber comprises fibers having a stiffness and strength that is greater than the first resin.

4. The method of claim 1, wherein the continuous reinforcing fiber comprises dry fibers.

5. The method of claim 1, wherein the continuous reinforcing fiber includes fibers and thermoset resin encapsulated in a sheath.

6. The method of claim 1, further comprising applying at least one of heat and pressure to the structural insert prior to encapsulation in the first resin.

7. The method of claim 1, wherein the continuous reinforcing fiber includes fibers and thermoplastic resin encapsulated in an outer layer.

8. The method of claim 1, further comprising encapsulating the structural insert in one of thermoplastic and thermoset resin prior to encapsulation in the first resin.

9. The method of claim 1, wherein:
the surface comprises one side surface of a body panel, and
the structural insert is encapsulated on the one side surface of the body panel using the first resin.

10. The method of claim 9, wherein another side surface of the body panel is painted.

11. The method of claim 9, wherein the composite panel has a composite density less than 1.50 g/cc, a tensile modulus greater than 2000 MPa in at least one direction, a coefficient of linear thermal expansion (CLTE) in at least one direction less than 40 ppm/C, a tensile strength in at least one direction that is greater than or equal to 50 MPa, and a composite thickness in a predetermined range from 2 mm to 8 mm.

12. The method of claim 1, wherein the continuous reinforcing fiber of the structural insert has thickness variations and extends non-uniformly in three planes.

13. The method of claim 1, further comprising selecting one or more fibers in the continuous reinforcing fiber and a fiber volume percentage of the continuous reinforcing fiber relative to the first resin to provide a first coefficient of linear thermal expansion of the composite panel in at least one direction to be within a predetermined range of a second coefficient of linear thermal expansion of a structure including a mounting location for the composite panel.

14. The method of claim 1, wherein the structural insert is anisotropic to vary at least one of local stiffness, thermal expansion, and strength as a function of location within the composite panel.

15. The method of claim 1, further comprising mixing the first resin with at least one of short fibers, long fibers, and one or more minerals prior to encapsulating the structural insert.

16. A method for manufacturing a composite panel, comprising:
arranging a continuous reinforcing fiber on a surface in a predetermined pattern to form a structural insert,
wherein the continuous reinforcing fiber is selected from a group consisting of dry fibers, fibers and thermoset resin arranged in an outer layer, and fibers and thermoplastic resin arranged in an outer layer, and
wherein the continuous reinforcing fiber is selected from a group consisting of carbon, glass, basalt, natural fibers, and combinations thereof; and
encapsulating the structural insert in a first resin to form a composite panel; and
at least one of:
painting an exterior surface of the composite panel;
applying a film to the exterior surface of the composite panel; and
using a transparent resin for the first resin to allow light to transmit through at least a portion of the composite panel.

17. The method of claim 16, wherein the continuous reinforcing fiber comprises the dry fibers.

18. The method of claim 16, further comprising applying at least one of heat and pressure to the structural insert prior to encapsulation in the first resin.

19. The method of claim 16, wherein:
the surface comprises one side surface of a body panel,
the structural insert is encapsulated on the one side surface of the body panel using the first resin, and
another side surface of the body panel is painted.

20. The method of claim 16, wherein the composite panel has a composite density less than 1.50 g/cc, a tensile modulus greater than 2000 MPa in at least one direction, a coefficient of linear thermal expansion (CLTE) in at least one direction less than 40 ppm/C, a tensile strength in at least one direction that is greater than or equal to 50 MPa, and a composite thickness in a predetermined range from 2 mm to 8 mm.
